(19) United States
(12) Patent Application Publication
(10) Pub. No.: US 2007/0184399 A1
(43) Pub. Date: Aug. 9, 2007

(54) Orthodontic bracket

(76) Inventor: Miguel A. Salich, San Juan, PR (US)

Correspondence Address: EUGENIO J. TORRES, 221 PLAZA BUILDING, PONCE DE LEON, SUITE 403, SAN JUAN, PR, 00917, US

(21) Appl. No.: 11/243,907

(22) Filed: Oct. 5, 2005

(51) Int. Cl. A61C 3/00

(52) U.S. Cl. 433/15

(57) ABSTRACT

An orthodontic device that comprises a single bracket that can work as a low, medium or high friction system, depending on the needs of the different stages of the orthodontic treatment.

### STATEMENT REGARDING FEDERALLY SPONSORED RESEARCH AND DEVELOPMENT

N/A

### RELATED APPLICATIONS

N/A

### BACKGROUND OF INVENTION

1. Field of the Invention

The present invention relates generally to the field of orthodontics and, more specifically, to a new orthodontic bracket that has four additional hooks attached thereto. The present invention permits to create low, medium or high friction brackets-arch wire systems depending on the number of hooks used to fix the elastic ligature and the arch wire to the bracket.

2. Discussion of the Invention

Since the appearance of the bonded brackets to the teeth enamel surfaces in the early 1970's, there have been all kind of modifications introduced in orthodontics. One of such modifications was the different angulations in each bracket. The object introducing said angulations being to get the best possible position of each tooth in the arch, and as a result, getting the best aesthetic appearance and functionality possible.

Since then, more than ten different prescriptions have been introduced. Usually, each one has the dentist's name. Another change developed later was putting the angulations in the base of the brackets, instead of in the outer portion as was done originally. Many side effects were corrected with this improvement.

Changes were introduced related to the size of the brackets. Smaller and smaller brackets have been developed for aesthetic reasons.

Porcelain brackets appeared later. These have some inconveniences like bulkiness, fragility, more friction in the system than stainless steel brackets, and, naturally, the price. Other changes are continually made related to the size and form of the bracket's base. Efforts are being made to get more adhesion of the brackets to the enamel surfaces. Also, there have been advancements made in the different wires developed.

First, the stainless steel wires which are still used extensively in orthodontics to the development of the niti wires in the 1980's. Great progress has been achieved in the refinement of the niti wires. Such progress, along with others, has permitted to practice orthodontics with less discomfort to the patient and less stress to the dentist. But in spite of all the advancements achieved in orthodontics there is one aspect that has been underestimated or not given the needed importance. That is, the problem of “friction” in the system bracket-wires. Some bracket designs have been proposed and are still used for this purpose. In the maxillary and mandibular arches alone, there will be 14 to 20 brackets. These will be engaged with two wires in the bracket slots.

Physical appearance has always been an axiomatic concern within societies. Throughout history there have been established certain aesthetical elements that define what beauty is. Those aesthetical elements include the establishment of hair-dress, make-up, and fashion trends as well as acceptable body shapes and other physical traits. In order to achieve those beauty parameters, people have engaged several methods to change those characteristics that differ from what has been denominated as beauty.

The appearance of teeth alignment has not escaped from this beauty conceptualization, a symmetric teeth alignment being what is accepted as beautiful. Orthodontics has been developed to respond to people's need of reaching the accepted parameters that beauty definition has imposed. In that direction all efforts to design and develop new orthodontics' devices and equipments have moved.

The evolution of orthodontics has been directed toward the development of techniques that could diminish treatment's time and patients' distress. In order to achieve this, it is necessary to recognize the needs and concerns of orthodontics' patients. In this particular matter, a great amount of orthodontics' patients are teenagers and young adults. Each of these groups has its unique concerns about the treatment to which they are going to be submitted. Teenagers are pleased to wear colored elastic ligatures, unlike young adults, which prefer more discreet and sober orthodontics devices and shorter treatments' periods. A successful orthodontics' invention should satisfy both, teenagers and young adults' needs.

The basic orthodontic treatment comprises three basics devices: bracket, arch wire and elastic ligatures. There have been several attempts to improve those devices in order to reduce treatment time and distress, but various deficiencies have arisen from those improvements that have diminished its contributory value.

The arch wire is the device that passes through the slot of each bracket giving cohesion to the bracket-arch wire system. This permits that an articulated, methodic and uniform treatment can be provided to patients. When tension is applied to the arch wire, an opposite force is created, transferred, and applied through the bracket to the teeth. The task of the arch wire is so important to the success of orthodontic treatment that several inventions have been created to improve the quality and effectiveness of arch wires.

In the development of new arch wires it is important to obtain a proper arch wire control. An effective arch wire control is of great importance throughout the whole orthodontic treatment because each phase of the treatment requires different amount of tension to be applied to the teeth. In order to apply the correct amount of tension, dentists need arch wires that can easily and effectively be manipulated. If improper arch wire control is exerted on the arch wire-bracket system, then the period of orthodontic treatment could be increased. All this is very important because throughout the treatment it is necessary to vary the tension exerted on the teeth in order to complete their correct alignment. The friction created between the arch wire and the bracket plays an important role in performing a fast and successful procedure. Responding to this, a series of inventions have been developed to modify the friction exerted between the arch wire and the bracket, improving the characteristics of the arch wire. The improvements made consist of changes on characteristics that permit to reach the exact friction requirement in each stage of the orthodontic treatment.

As said, the orthodontic treatment has different tension requirements throughout its duration. During the early stages it is preferred to permit a somewhat free movement between the arch wire and the bracket so that the teeth are not restrained from corrective movement. In contrast, if there is too much friction exerted on the teeth a resistance to realignment is created. In other words, it is necessary to decrease the resistance created between the arch wire and the bracket in order to achieve fast and correct teeth realignment. The decrease in exerted friction also permits a less painful treatment. At the same time, during the late stages of the treatment it is necessary to obtain more control over the teeth alignment. As has been demonstrated, there is a continuous need to selectively control the friction created between orthodontic brackets and arch wires to permit rapid teeth alignment during early stages of the treatment and more controlled alignment during the later stages of treatment.

The most successful invention so far has been the niti wires. They were developed in the 1980's and have been used in place of stainless steel wires because of its better results in achieving a fast, less painful treatment. The niti wires avoid the displacement of well-positioned teeth when correcting the wrong alignment of other teeth. It has been observed that the use of niti wires with low friction brackets, instead of the regular mini-brackets, considerably reduces the time and pain associated with the orthodontic treatment. The disclosed invention comprises the use of a new mini-bracket designed to produce results like those of the low-friction bracket when used with niti wires.

On the other hand, the brackets are the fundamental element of the entire orthodontic treatment. Through them, the tension necessary to correct teeth's wrong alignment is exerted on the teeth. The type of bracket that is used most commonly by dentists in orthodontic treatment is the mini-bracket. Even though this is the type of bracket most widely used, it is not the one that offers the best results. Other types of brackets as well as modifications to the mini-brackets have been introduced in order to improve the results of the treatment. Among all the inventions the low-friction brackets have arisen. These brackets have demonstrated a higher efficiency in achieving treatment's goals in a shorter time and diminishing the pain associated with teeth's realignment. The improvements observed in treatments using low friction brackets are directly associated to the reduction of friction exerted on the arch wire-bracket system. The effectiveness of these brackets is increased when they are used in combination with niti wires. This combination avoids the “bumping out” effect that occurs in the high friction system. This effect causes a forward movement of anterior teeth when aligning a particular tooth.

There are some defects that undermine low friction brackets efficiency. First of all, they are bulky if compared with mini-brackets. This has the effect of making them esthetically less attractive to those who wear them. Also, it is difficult for dentists and technicians to work with them because their slots' locks break easily. Their fragility has the effect of increasing the costs of the treatment and creates stressful situations for dentists and technicians. When talking of costs increase it has to be understood that the increase associated with low friction bracket breakage has to be added to the high cost low friction brackets have. A low friction brackets set could be as expensive as fifteen (15) times the cost of a set of mini-brackets. A large number of dentists are reluctant to engage in such an expense.

The disclosed invention is intended to fulfill the technical and mechanical advantages that low friction brackets contribute to the orthodontic treatment, combining as well the more accepted esthetical characteristics of mini-brackets. The fulfillment of low friction brackets characteristics is achieved by adding more hooks to the traditional mini-bracket permitting it to recreate a low friction bracket-arch wire system.

The disclosed embodiment of the present invention helps in offering a new mini-bracket design that will give to the mini-bracket the mechanical characteristic of low friction brackets that permit to provide a faster and less painful orthodontic treatment. These improvements do not have an adverse effect in mini-brackets cost or esthetical characteristics.

There are certain devices in the prior art that differ ones from the others in the specific design of the brackets' hooks. Prior art has not foreseen the disclosed invention's integration of additional hooks to brackets in perpendicular position in relation to the existing hooks. For instance, U.S. Pat. No. 5,607,299 to Nicholson ('299) discloses a device consisting of a bracket with two spaced tie wings with central slots in each tie wing. This prior art gives the opportunity to add some grooves between the tie wings to reduce the friction in the arch wire-bracket system. However, the invention disclosed in this application is patentably distinct and a unique improvement from the device disclosed in '299 in several different aspects. For instance, the disclosed preferred embodiment of the present invention is not limited to redesign shape and alignment of existing hooks but attached additional hooks to both ends of the horizontal plane of the bracket. The addition of those hooks permits dentists to convert the arch wire-bracket system from a high friction system to a low friction system. This variability of friction degree enables dentists to modify the system throughout the treatment in order to minimize the treatment's duration.

Therefore, it can be appreciated that there exists a continuing need for a new and improved device for the reduction of time and pain associated with orthodontic treatment. The use of additional hooks attached to the bracket permits to merge in a single device the benefits of the prior art mechanism and at the same time to overcome deficiencies in the prior art esthetics, complexity and cost. In this regard, the present invention substantially fulfills these needs. The present invention overcomes the inability of the prior art to provide a bracket that could combine characteristics of low friction systems, the esthetical and economical convenience of high friction systems and the chance of converting a bracket-arch wire system from a high friction system to a low friction system and vice versa. Various novel devices have recently been disclosed, yet none provide a more practical and cost efficient bracket device for the reduction of cost, time and pain associated with orthodontic treatment.

None of the art considered above, taken either simply or in combination teaches the design of a bracket which offers benefits of high friction and low friction systems in a single device. In light of the foregoing, it will be appreciated that what is needed in the art is an orthodontic device, more specifically a bracket that incorporates the teachings of the present invention.

### SUMMARY OF THE INVENTION

The object of the present invention is to provide a device consisting of a bracket, which combines the benefits of high and low friction bracket-arch wire systems.

It is a further object of the present invention to provide an orthodontic device having dimensions and appearance esthetically acceptable to patients.

It is still a further object of this invention to provide patients with an orthodontic device having low friction systems characteristics but also having a cost as low as high friction systems.

It is an object of the present invention to provide patients with an orthodontic device that diminishes time and pain associated with orthodontic treatments.

It is an object of the present invention to enable a high friction arch wire-bracket system to work like a low friction system improving a high friction bracket attaching to it additional hooks that permit to change the bracket-arch wire system from a high friction one to a low friction one, and vice versa.

The invention itself, both as to its configuration and its mode of operation will be best understood, and additional objects and advantages thereof will become apparent, by the following detailed description of a preferred embodiment taken in conjunction with the accompanying drawing.

When the word “invention” is used in this specification, the word “invention” includes “inventions”, that is, the plural of “invention”. By stating “invention”, the Applicant does not in any way admit that the present application does not include more the one patentable and non-obviously distinct invention and Applicant maintains that the present application may include more than one patentably and non-obviously distinct invention. The Applicant hereby asserts, that the disclosure of the present application may include more than one invention, and, in the event that there is more than one invention, that these inventions may be patentable and non-obvious one with respect to the other.

Further, the purpose of the accompanying abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

FIG. 1 is a drawing of the invention arranged to work like a high friction system.

FIG. 2 is a drawing of the invention arranged to work like a medium friction system.

FIG. 3 is a drawing of the invention arranged to work like a low friction system.

FIG. 4 is the top view of the invention arranged to work like a high friction system.

### DESCRIPTION OF THE PREFERRED EMBODIMENT

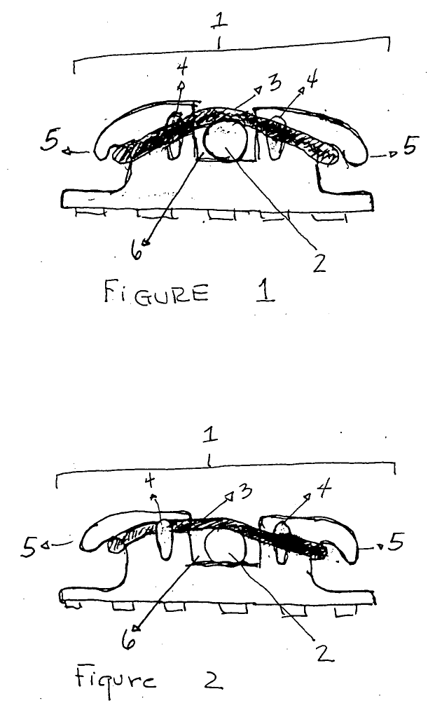

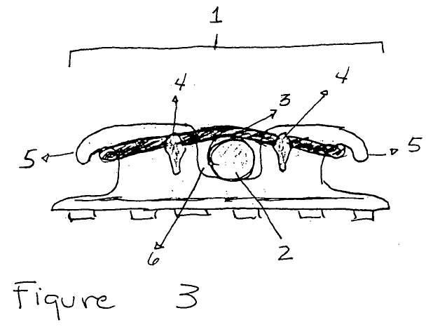

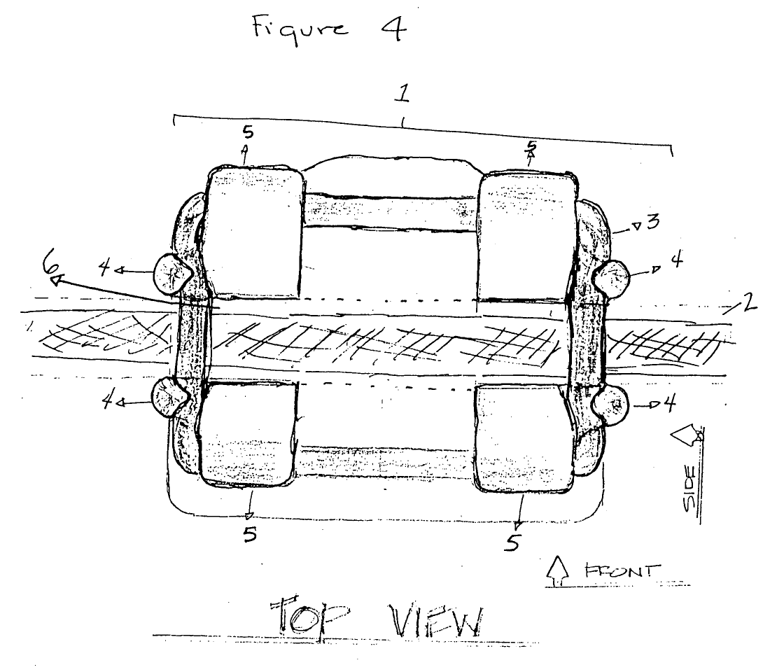

Turning to the drawings, the present invention comprises a device, specifically an orthodontic bracket 1 that has additional lateral hooks 4 attached to the it that permits dentists to create a low friction FIG. 1, medium friction FIG. 2, or high friction FIG. 3 system between the bracket 1 and the arch wire 2, depending on the requirements of the different stages of the orthodontic treatment.

As it can be appreciated on FIG. 4, the bracket-arch wire system of the present invention, provides the opportunity to control the amount of force, and in consequence the amount of friction, that is exerted on it. The arch wire 2, like in every bracket-arch wire system, passes through the slot 6 that is vertically aligned in the center of the bracket 1. The arch wire 2 is held in position by the elastic ligatures 3 that are fixed to the normal hooks 5 of the bracket 1. The ability of the present invention of providing a single device that can configure different kinds of brackets-arch wire system resides in the attachment of four additional lateral hooks 4. In order to exert forces of different magnitudes to the bracket-arch wire system the elastic ligatures 3 shall be positioned on different patterns with respect to those lateral hooks 4. This will determine the magnitude and type of force that is exerted on the arch wire 2 and the bracket 1.

There are three types of bracket-arch wire systems that can be created with the present invention. They are: (1) the high friction system; (2) the medium friction system; and (3) the low friction system.

In the high friction system FIG. 1, the elastic ligature 3, in order to exert higher pressure on the arch wire 2 and the bracket 1, is fixed on the normal hooks 5, but not onto the lateral hooks 4. By passing the elastic ligature 3 around the lateral hooks 4, the elastic ligature 3 will be tenser. This tension will exert a greater force on the arch wire 2 than any other that could possibly be exerted in a bracket-arch wire system.

In the medium friction system FIG. 2, the elastic ligature 3 goes around the one lateral hook 4 at each side and fixed to the remaining lateral hook 4 in each side.

In the low friction system FIG. 3, the elastic ligature 3 goes fixed to each of the lateral hooks 4. This permits to exert a lighter force against the arch wire 2 and the bracket 1.

The invention is not limited to the precise configuration described above. While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

What I claim is:

1. An orthodontic system for the alignment of teeth comprising:
(a) an arch wire;
(b) a bracket having a slot that is vertically aligned to the center of the bracket, two pairs of first hooks each pair disposed at opposite ends of the slot and wherein each particular first hook faces away from the slot but towards the bracket and two pairs of second hooks each pair disposed at opposite ends of the slot wherein each said second hook is disposed perpendicularly to each said first hook and wherein each particular second hook faces away from the bracket;
(c) an elastic ligature fixed hooked on to each of the first hooks;
wherein said arch wire is held in position by the elastic ligature and wherein the magnitude of the force exerted by said elastic ligature on the system are controlled by positioning said elastic ligature on different positions with respect to said second hooks.

2. A method of using the orthodontic system of claim 1 to control the amount of friction exerted on teeth, comprising the steps of:
(i) fixing the elastic ligature to the first hooks; and
(ii) not fixing the ligature to the second hooks to obtain a high friction system as a result the elastic ligatures will be more tense; or, to obtain a medium friction system, fixing the elastic ligature around only one of the second pair of hooks; or, to obtain a low friction system, fixing the elastic ligature to each of the second hooks exerting a lighter force against the arch wire and the bracket.
